(19) United States
(12) Patent Application Publication
(10) Pub. No.: US 2007/0254545 A1
(43) Pub. Date: Nov. 1, 2007

(54) ANISOTROPIC EXTENSIBLE NONWOVENS

(75) Inventor: KENNETH E. MARTIN, Newark, DE (US)

Correspondence Address: INVISTA NORTH AMERICA S.A.R.L., THREE LITTLE FALLS CENTRE/1052, 2801 CENTERVILLE ROAD, WILMINGTON, DE, 19808, US

(73) Assignee: INVISTA NORTH AMERICA S.A.R.L, Wilmington, DE (US)

(21) Appl. No.: 11/740,974

(22) Filed: Apr. 27, 2007

Related U.S. Application Data
(60) Provisional application No. 60/795,525, filed on Apr. 27, 2006.

(51) Int. Cl. B32B 37/00; D04H 13/00; D04H 1/56; D04H 3/16

(52) U.S. Cl. 442/328; 442/400; 442/401; 156/290

(57) ABSTRACT

This invention relates to nonwoven fabrics in which the fibers of the fabric are laid down such that a majority of the fibers have a fiber direction making an angle substantially parallel to or within an angle in a range of +/−45° of the machine direction. The invention also relates to a nonwoven fabric bonded web having bonding points in a pattern arranged along an axis perpendicular to the machine direction spaced and more widely apart than the bonding points arranged along an axis parallel to the machine direction. The resulting nonwoven having a very low elongation in the machine direction can be elongated with relatively little force in the cross machine direction.

### FIELD OF THE INVENTION

This invention relates to nonwoven fabrics in which the fibers of the fabric are laid down with an orientation primarily in a machine direction. The resulting nonwoven has high tensile strength and very low elongation in the machine direction, but relatively low tensile strength and can be elongated with relatively little force in the cross direction. In a process for making this nonwoven, the required fiber orientation property is obtained without a separate step of “consolidation” or “necking.”

### BACKGROUND OF THE INVENTION

Stretch nonwovens are enjoying rapid growth in the hygiene industry. The majority of products in use either have a machine direction stretch capability, such as the Kimberly Clark Demique® and “Flex-All” products or cross direction stretch such as the “Golden Phoenix” or “Tredegar” nonwoven—elastic film laminates. However, a true multi-direction stretch nonwoven provides valuable functionality to hygiene related products as well as opening new end uses such as apparel to stretch nonwovens.

Commercial producers have made fully elastic multi-directional spunbond nonwovens by using elastomeric thermoplastic polymers in conventional spunbond processes. However these products, while exhibiting excellent elasticity also have an objectionable rubber like hand that is characteristic of elastic polymers. It is known to produce nonwovens with fibers oriented primarily in the machine direction by a post production “necking” or “consolidation” step in which the nonwoven is drawn in the machine direction in a separate step after it is initially produced. United States patents assigned to the University of Tennessee and related to and disclosing, in part, this technology include:

U.S. Pat. No. 5,441,550 (Issued Aug. 15, 1995);

U.S. Pat. No. 5,443,606 (Issued Aug. 25, 1995);

U.S. Pat. No. 5,486,411 (Issued Jan. 23, 1996);

U.S. Reissue Pat. No. 35,206 (Issued Apr. 16, 1996; Reissue of U.S. Pat. No. 5,244,482);

U.S. Pat. No. 5,599,366 (Issued Feb. 4, 1997);

U.S. Pat. No. 5,730,923 (Issued Mar. 24, 1998);

U.S. Pat. No. 5,747,394 (Issued May 5, 1998);

U.S. Pat. No. 6,030,906 (Issued Feb. 29, 2000).

In view of the disclosures of the prior art it remains clear that the necking or consolidation processes provide a nonwoven product with at least the desirable cross direction extensibility. This cross direction extensibility is obtained after a second step following production of a nonwoven. The added costs of this step to the overall process are a deficiency to an economically viable route to the product.

### SUMMARY OF THE INVENTION

Herein disclosed is an invention providing a cross directionally extensible nonwoven produced directly without a consolidation or necking step.

The nonwoven provided by the process herein disclosed has substantially different physical properties in the machine direction versus the cross direction characterized in that said nonwoven has a cross direction elongation at break of at least about 50 percent. Substantially different physical properties refer to at least the elongation without rupture in the machine direction and the perpendicular direction.

The nonwoven provided in an embodiment herein has a cross direction elongation at break of about 100 to about 200 percent.

The nonwoven provided in embodiments herein is selected from the group comprising spunbonded, melt blown, carded thermal bond, and spunlaced structures.

Provided by the disclosures herein is a process for making a nonwoven having substantially different physical properties in the machine direction versus the cross direction comprising the steps of: laying down a fibrous web, followed by bonding the web. The process provided substantially aligns the fibers of the nonwoven in the machine direction and bonds the resulting web such that the resulting material has cross direction extensibility but with sufficient cross directional and machine directional coherence to allow subsequent conversion steps.

Provided in an aspect of the invention is a process for making an extensible nonwoven comprising the steps of laying down a fibrous web and bonding the web by selecting a bonding pattern comprising a small number of bonding points and wherein, the bond points arranged along an axis perpendicular to the machine direction are spaced more widely apart than the bond points arranged along an axis parallel to the machine direction and wherein the bond points are provided by thermal energy.

Provided in an aspect of the invention is a process for making an extensible nonwoven comprising the steps of aligning carded bats of fibers such that a majority of the fibers have a fiber direction making an angle substantially parallel to or within an angle in a range of +/−45° of the machine direction and bonding the web.

### DEFINITIONS

The following non-limiting definitions comprise a glossary of stretch nonwoven technology terms. These definitions are meant to guide the skilled person to a clear and concise meaning for the various terms of art as used herein.

LYCRA® XA, a registered trademark of INVISTA S. à r. l., 3 Little Falls Centre, 2801 Centreville Road, Wilmington, Del., 19808. LYCRA® fibers specifically designed to be adhesively attached rather than knitted or woven into place and used diapers and adult incontinence products. “XA” stands for “Extra Adherent” or “Extra Adhesive”.

Decitex and denier relative thickness of a yarn, a linear density. Decitex is weight in grams of 10,000 meters of yarn. Denier is weight in grams of 9,000 meters of yarn.

Machine Direction Axis of a nonwoven fabric is that direction parallel to the direction in which the fabric is forwarded through the machine; the direction in which the fabric is made.

Cross Direction Axis of a nonwoven fabric is that direction perpendicular to the direction in which the fabric is made.

Consolidated Nonwoven is one that can be extended (stretched) in the cross direction (also known as a “necked” direction) with a relatively low force. Normally, consolidated nonwovens have a low retraction power and high permanent set (deformation) after extension. Consolidated nonwovens are produced from almost any normal “as made” nonwoven by a drafting process (e.g. “the Kimberly Clark” technology) or drafting plus heat (the University of Tennessee TANDEC) process. Consolidated nonwovens normally have high modulus and tensile strength in the machine direction, e.g. elongation without rupture to 200 or 250% is possible.

Extensible Nonwoven is one that can be extended in the cross direction with relatively low force. Such nonwovens can be either a consolidated nonwoven or an “as made” extensible nonwoven. “As-made” extensible nonwovens have characteristics similar to consolidated nonwovens but generally having lower elongation but not as a result of a special necking or consolidation process.

Anisotropic Nonwoven are ones having different properties (e.g. elongation and tensile strength) in the machine direction versus the cross machine direction. Anisotropic nonwovens are “as-made” extensible nonwovens.

GSM “grams per square meter” The common measure of the weight or thickness of a nonwoven per unit area. Normally, these range from 10 GSM at the low end of spunbond and melt blown nonwovens up to 100-400 GSM for needle punch nonwovens. For example, “diaper cover stock” nonwovens are in the range of 15 to 25 GSM.

MDXA “Machine Direction XA” A laminate of LYCRA® spandex fibers and a nonwoven or a film (e.g. nonwoven/LYCRA®/nonwoven). LYCRA® under extension is adhesively bonded to the nonwoven using a hot melt adhesive. The laminate forms a characteristic puckered pattern when allowed to retract. The MDXA family of product properties differ significantly depending on LYCRA® spacing, decitex and type of nonwoven or film.

CDXA (also known as CDXA-I) “Cross Direction XA” A laminate of LYCRA® spandex fibers between layers of nonwoven in which the LYCRA® fibers are laid down in a “zig zag” pattern. The LYCRA® fibers are extended when glued in place and product has a characteristic puckered appearance when allowed to relax. The CDXA product is normally a narrow tape that is rigid in the machine direction but elastic (stretches and recovers) in the cross direction. Intended for cross direction stretchable components in diapers and adult incontinence products, such as waistbands, side panels, elastic diaper ears and closure tapes.

CDXA-III (so-called “version 3” and a successor to CDXA) This product is a laminate having a single layer of an extensible nonwoven that is impregnated with a hard segment and soft segment polyurethane polymer; essentially the same polymer used to make LYCRA® spandex filaments. This impregnated laminate of high retractive power is an extensible nonwoven produced by a coagulation coating process. The impregnated laminate is characteristically rigid in the machine direction and elastic in the cross direction.

EDXA “Every Direction XA” A nonwoven with multiple direction (both machine and cross direction) stretch and recovery. Examples are spun bonded nonwovens made using thermoplastic elastomeric polymers by ADC (Advanced Design Concepts GmbH), Germany.

Nonwoven Production Technologies: Nonwoven production can be divided into three parts: “Web Formation, Bonding, and Finishing”

Web formation can be divided into “Spun Melt” processes that begin with thermoplastic polymer chips, “Flash Spun” nonwovens are a solvent spun version of “Spun Melt” nonwovens, and “Carded or Air Laid” nonwovens begin with staple fibers. “Spun Melt” is further divided into “Spun Bond” and “Melt Blown” nonwovens. Fibers in spun bond nonwovens are melt spun into an air extension chamber where the fibers are drawn to increase strength by an “air attenuation” process and then laid down on a moving belt. In a melt blown process, the polymer melt is extruded into a high shear zone powered by air which breaks the fibers into small sections and draws them while in the molten state into very fine deniers. Spun bond is the most common nonwoven process, producing a strong, durable nonwoven fabric in wide use in the hygiene industry (e.g. diapers). Melt blown fabrics are normally weak but with very fine and uniform pore size and are commonly used in filtration.

Spun bond, melt blown and flash spun nonwovens are normally consolidated by a thermal bonding process. Hybrid nonwovens, for example SMS, or SMMS (spun bond/melt blown/spun bond) are becoming increasingly common. In flash spun nonwovens, a polymer (commonly polyethylene and polypropylene or mixtures) is dissolved under pressure in a low boiling solvent which vaporizes immediately upon pressure let down and extrusion of the polymer solution from a spinneret. The most important flash spun nonwoven is TYVEK® from E. I. Du Pont de Nemours and Co. Inc, Wilmington, Del.

Carded or Air Laid nonwovens begin with staple fibers which are formed into webs by either a conventional carding or by air laying in which individual fibers are conveyed into a web by an air stream. Carded and air laid nonwovens are bonded by processes employing thermal, chemical or by mechanically bonding means.

“Web bonding” is the process used to bind fibers of the nonwoven web together. There are generally three web bonding types: “Thermal Bonding” which partially melts fibers together, usually by a calender roll with a raised pattern that bonds the web together at specific points (dots) in the fabric. “Chemical (or Adhesive) Bonding” that bonds fibers together using a resin or adhesive. “Mechanical Bonding” is achieved using a large number of steel needles are repeatedly passed through the fabric to entangle the fibers, also known as needle punched. Similarly, high-pressure water jets are used to accomplish fiber entangling and often calles spunlaced or hydro-entangled nonwovens. SONTARA® from E. I. Du Pont de Nemours and Co. Inc, Wilmington, Del. is an example of a spunlaced nonwoven. Spunlaced nonwovens are more three-dimensional and fabric like than other nonwovens and are generally viewed as the high quality end of the nonwoven spectrum.

“Web finishing” refers to a finish or treatment, usually a chemical compound, applied to a nonwoven to impart some characteristic, usually hydrophilicity.

### BRIEF DESCRIPTIONS OF THE DRAWINGS

FIG. 1A is a representation of a portion of a stretch nonwoven 10 having a plurality of bonding points 20.

FIG. 1B is a representation of a portion of a stretch nonwoven 100 having a fibers 200 aligned within an angle +/−a of the machine direction MD.

FIG. 2A is flow diagram of one process for providing a stretch nonwoven according to the invention.

FIG. 2B is flow diagram of another process for providing a stretch nonwoven according to the invention.

### DETAILED DESCRIPTION

According to this invention, a fully elastic nonwoven with a cloth like hand is provided by surrounding a primary spunbond elastomeric nonwoven (such as that based on EXXON VISTAMAXX® elastomeric polypropylene) by light weight layers of spun bond or melt blown hard fibers such as polypropylene, polyethylene, polyester, or polypropylene—polyethylene blends by spunbonded, meltblown and hybrid combination of the two processes. In this process, deposition of a layer of hard fiber on either side of the spunbond elastomer that is thin enough and lightly bonded enough to not hinder stretch and recovery of the center elastomeric layer. The elastic nonwoven is enhanced by using a high quality melt spun elastomer as the primary elastic layer.

According to an aspect of the invention provided are nonwoven fabrics in which the fibers of the fabric are intentionally laid down with an orientation primarily in a machine direction. The resulting nonwoven has high tensile strength and very low elongation in the machine direction, but relatively low tensile strength and can be elongated with relatively little force in the cross direction. In a process for making this nonwoven, the required fiber orientation property is obtained without a separate step “consolidation” or “necking.”

Nonwovens with substantially different properties in the cross direction versus the machine direction means that the resulting nonwoven, hereinafter an “extensible nonwoven”, is rigid with high break tenacity in the machine direction. At the same time the extensible nonwoven is easily extended in the cross direction without rupturing by application of a relatively low force. A relatively low force is an applied force of less than 1 Newton at 50% elongation.

Normally, care is taken in the production of nonwovens to randomize the direction of the fiber lay down to produce a sheet structure with similar physical properties (modulus, percent elongation and break tenacity) in all directions. However, extensible nonwovens have been shown to be useful in producing a variety of materials that utilize nonwoven sheets with cross direction.

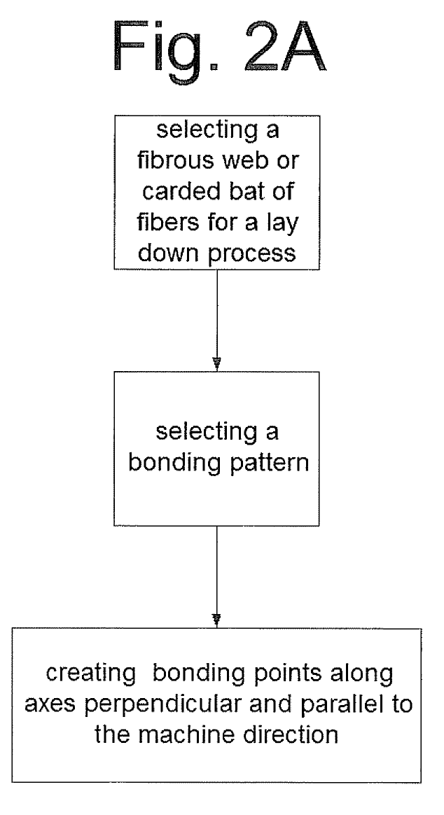

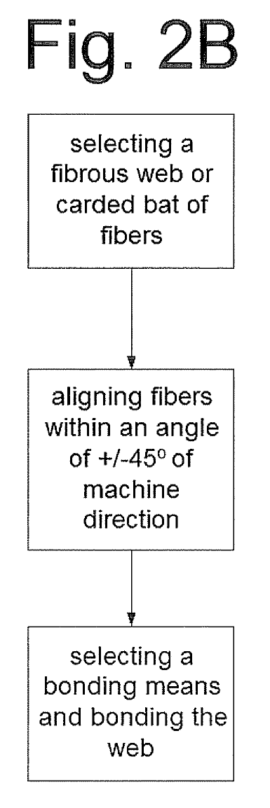

Extensible nonwovens with cross direction stretch of 200% are well known, but are produced by a post nonwoven formation conversion process. Patent disclosures relating to this technology are assigned to TANDEC (University of Tennessee Nonwovens Research Consortium), Kimberly Clark, and BBA. According to the disclosure of U.S. Reissue Pat. No. 35,206, processes commonly known as “necking” or “consolidation” start with a nonwoven, especially spun-bond and carded thermo-bond nonwovens, which is then drawn in the machine direction to substantially align the fibers of the nonwoven in the machine direction to produce the desired properties. In addition, spun-laced (hydro-entangled) nonwovens produced by a variety of producers, including E. I. DuPont, Sheng Hung, and BBA have properties that are similar to the desired “extensible” nonwoven due, but with elongation's generally less than 100%. In this invention, an extensible nonwoven is produced directly during the nonwoven formation process without the need for post formation processing and represented by the flow charts of FIGS. 2A and 2B.

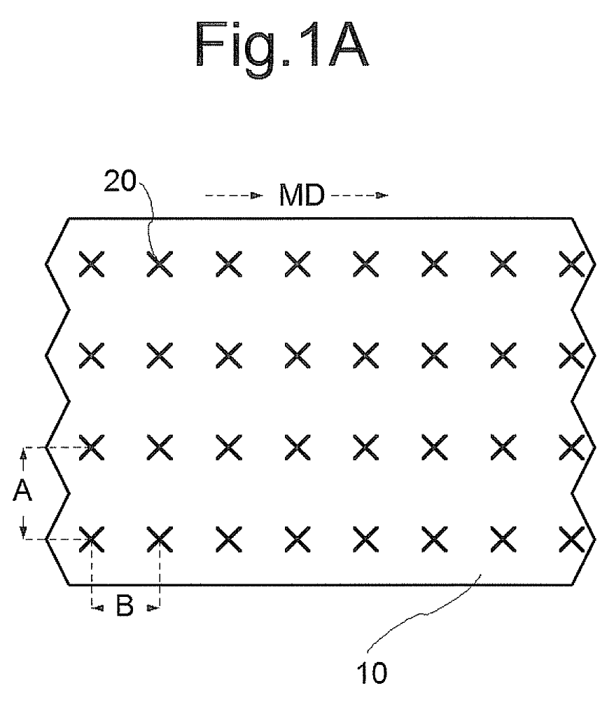

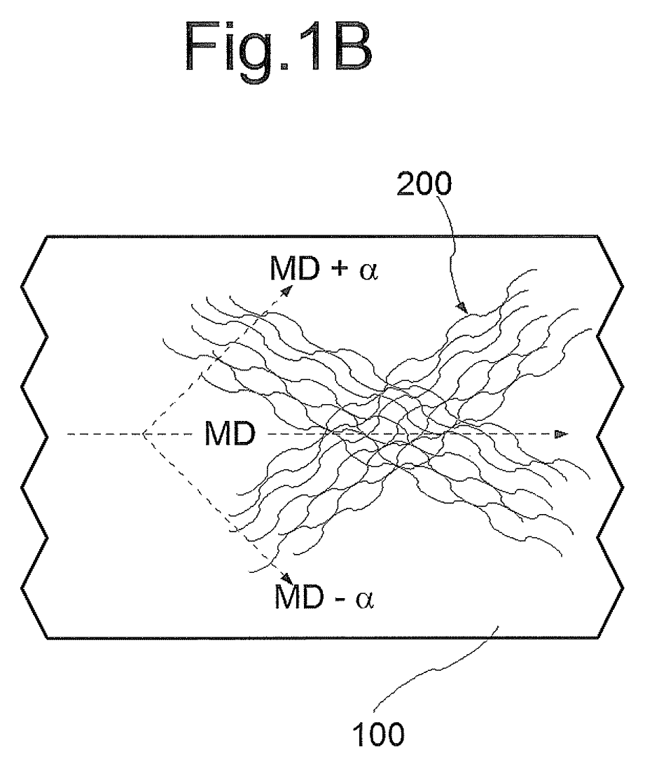

In the case of a nonwoven based on a fibrous web (in FIG. 1A), The extensible character of the nonwoven is enhanced by selecting a bonding pattern with a relative low number of bond points 20 (in FIG. 1A) and/or one in which the bond points are arranged such that bond points 20 along an axis perpendicular to the machine direction are widely spaced, e.g. having spacing A in FIG. 1A, while those on an axis parallel to the machine direction are relatively closely spaced, e.g. having a spacing B in FIG. 1A. In general, bonding point spacing satisfies the relationship A>B. More particularly, the bond point spacing is selected in order that A=1.1(B) at least, and more generally A>2(B). In the case of a spun-bond nonwoven, the bonding point pattern is accomplished by appropriate adjustment of the randomizing air jets at the fiber lay down point to produce the same fiber lay down as described above for carded thermo-bond nonwovens and also using the bonding patterns described above.

In the case of a nonwoven based on a carded web (in FIG. 1B), aligning the carded bats forming the nonwoven in such a manner that the fiber direction is either substantially parallel to or within an angle +/−a, where a is 45° of the machine direction. The coherent character of the nonwoven so-formed is enhanced by bonding using known bonding means.

### Test Methods

Elongation at Break based on ASTM D 5035-90.

1. An extensible nonwoven having substantially different physical properties in the machine direction versus the cross direction, characterized in that said nonwoven has a cross direction elongation of at least about 50 percent.

2. The extensible nonwoven of claim 1 having a cross direction elongation of about 100 to about 200 percent.

3. The extensible nonwoven of claim 1 selected from the group comprising:
spunbonded, melt blown, carded thermally bonded, and spunlaced structures.

4. A process for making an extensible nonwoven comprising the steps of: laying down a fibrous web and bonding the web by selecting a bonding pattern comprising a plurality of bonding points and wherein, the bonding points arranged along an axis perpendicular to the machine direction are spaced more widely apart than the bond points arranged along an axis parallel to the machine direction and wherein the bonding points are provided by thermal energy.

5. A process for making an extensible nonwoven comprising the steps of: aligning carded bats of fibers such that a majority of the fibers have a fiber direction making an angle substantially parallel to or within an angle in a range of +/−45° of the machine direction and bonding the web.

6. A process for making an extensible nonwoven comprising the steps of: laying down a fibrous web using randomizing air jets such that a majority of the fibers have a fiber direction making an angle substantially parallel to or within an angle in a range of +/−45° of the machine direction and bonding the web.
